(19) United States
(12) Patent Application Publication
(10) Pub. No.: US 2005/0060327 A1
(43) Pub. Date: Mar. 17, 2005

(54) Spare part lineup selection system

(76) Inventors: Jiro Kawahara, Tokyo (JP); Keiji Suzuki, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/931,209

(22) Filed: Sep. 1, 2004

(30) Foreign Application Priority Data
Sep. 5, 2003 (JP) JP2003-314115

(51) Int. Cl. G06F 17/00

(52) U.S. Cl. 707/100

(57) ABSTRACT

In a spare part lineup selection system, after a drawing has been issued for each part or part assembly of the group of parts constituting the completed product and a symbol has been selected from among a group of symbols indicating rank in physical function and an operator inputs information of the drawing that identifies the part or part assembly together with the selected symbol, the inputted drawing information is registered in a shelf corresponding to the selected symbol from among shelves provided in a drawing information server for the respective symbols, the server is then accessed and the drawing information registered in one from among the shelves that correspond to a predetermine first symbol, and the part or part assembly identified by the drawing information extracted from the shelf corresponding to the predetermined first symbol is determined or selected as a spare part to be sold.

### BACKGROUND OF THE INVENTION

1. Field of the Invention

This invention relates to a spare part lineup selection system.

2. Description of the Related Art

Many manufactured products (completed products) such as motor vehicles comprise a large group of parts and the manufacturer is required to decide which of the parts are to be sold as spare parts for servicing.

Conventional technologies regarding spare part marketing and the like are set out in, for example, Development of New Technical Information System for Servicing Parts, Takahashi et al., Automotive Technology, Vol. 47, No. 2, 1993. In this publication, the authors teach that timely and accurate supply of spare parts can be realized through more extensive automation achieved by, for example, utilizing a system configuration based on distributed processing rather than batch processing and completely automating the assignment of part codes.

On the other hand, Japanese Laid-Open Patent Application No. 2003-114899 ('899), although not related to spare parts, teaches a technology for facilitating searches for alternative parts that is aimed at enhancing convenience in product design and procurement of product constituent parts. The technology taught by '899 consists in reading stored information regarding part category, displaying the information serially according to the classification hierarchy, and listing parts that fall in the same category as the designated part or part assembly.

### SUMMARY OF THE INVENTION

However, the technologies set out in Takahashi et al. and '899 do not go beyond what is described above, i.e., these references do not teach a technology for determining a spare part lineup by deciding which parts among the group of parts making up a completed product (manufactured product) are to be sold.

The determination of spare part lineups has conventionally been done manually by the person in charge. As a result, misjudgments and wrong decisions have been frequent and work efficiency low. Against the backdrop of the rapid increase in the number of completed models offered to respond to diversifying customer tastes in recent years, there has been an increase in the number of part groups along with a proportional increase in inventory levels and related costs. A strong and urgent need is therefore being felt for a system that enables simple and appropriate decisions regarding whether or not specific ones of such parts should be sold so as to determine the lineup of spare parts for product servicing.

An object of the present invention is therefore to overcome the aforesaid problems by providing a spare part lineup selection system that processes the group of parts constituting each completed product (manufactured product) to decide simply and quickly whether or not they are to be sold, thereby determining a spare part lineup, and that is capable of preventing an increase in inventory levels even when an increase in the number of completed models causes an increase in the number of part groups.

In order to achieve the object, there is provided a system for selecting a spare part lineup by determining which part or part assembly among a group of parts constituting a completed product is to be sold and having a drawing information server; comprising: a drawing information terminal connected to the drawing information server and, after a drawing has been issued for each part or part assembly of the group of parts constituting the completed product and a symbol has been selected from among a group of symbols indicating rank in physical function and prepared to be assigned to the group of parts constituting the completed product, allows an operator to input information of the drawing that identifies the part or part assembly, together with the selected symbol; a drawing information register that registers the inputted drawing information in a shelf corresponding to the selected symbol from among shelves provided in the drawing information server for the respective symbols; a drawing information extractor that accesses the drawing information server and extracts the drawing information registered in one from among the shelves that correspond to a predetermine first symbol; and a spare part line up register that determines and registers in the drawing information server that the part or part assembly identified by the drawing information extracted from the shelf corresponding to the predetermined first symbol is a spare part to be sold.

### BRIEF DESCRIPTION OF THE DRAWINGS

The above and other objects and advantages of the invention will be more apparent from the following description and drawings, in which:

FIG. 1 is an overall schematic diagram of a spare part lineup selection system according to an embodiment of this invention, also showing processing conducted after establishment of a lineup;

FIG. 2 is a flowchart showing processing steps at the first stage of operation of the system shown in FIG. 1;

FIG. 3 is a diagram illustrating the function assurance concept underlying the system of FIG. 1 that is used to explain the relationship between (a) the setting of desired functions to be performed by the completed vehicle and (b) the spare parts to be used in servicing;

FIG. 4 is a diagram similar to FIG. 3 illustrating the function assurance concept underlying the system of FIG. 1 that is used to explain concrete part design for achieving the desired functions to be performed by the completed vehicle;

FIG. 5 is a flowchart showing operations of the system of FIG. 1 that are executed following those of FIG. 2;

FIG. 6 is an explanatory diagram showing exception condition registration of lineup parts used in the processing of the flowchart in FIG. 5; and

FIG. 7 is another explanatory diagram showing exception condition registration of lineup parts used in the processing of the flowchart in FIG. 5.

### DETAILED DESCRIPTION OF THE PREFERRED EMBODIMENTS

Preferred embodiments for implementing the spare part lineup selection system according to this invention will now be explained with reference to the attached drawings.

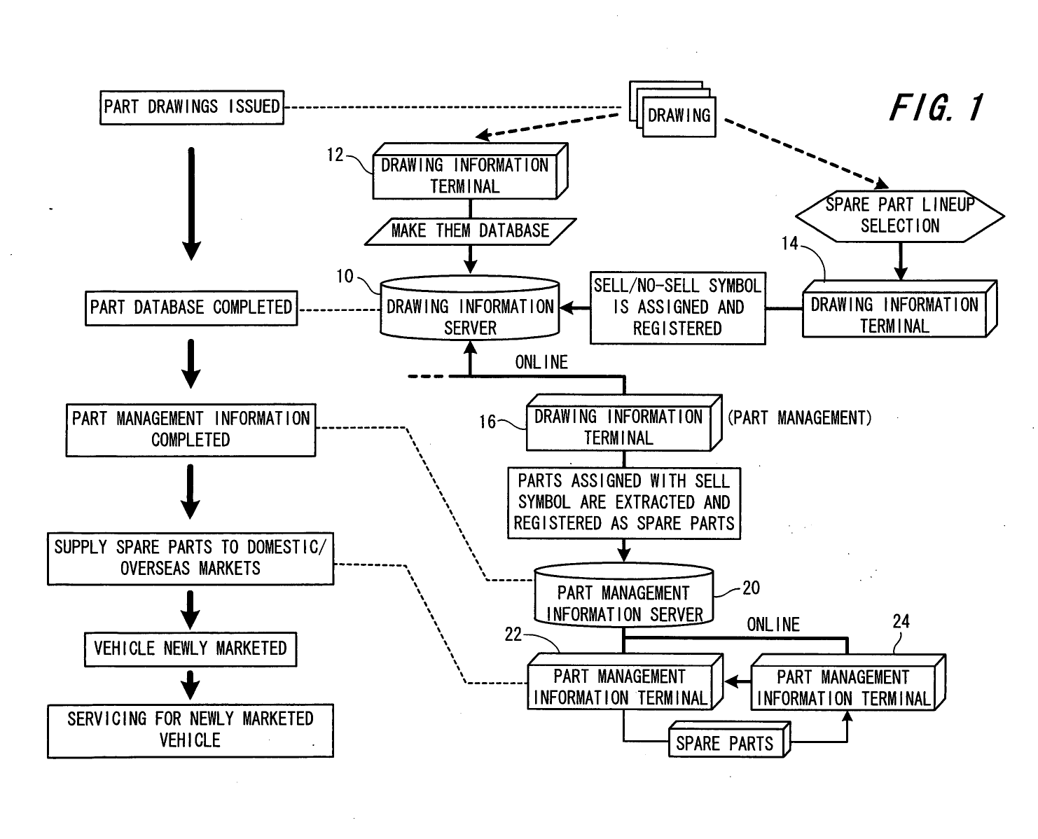

FIG. 1 is a schematic diagram of a spare part lineup selection system according to an embodiment of this invention, also including the supply of parts for servicing. As used in this specification, the term “spare part lineup selection” means, as discussed in the foregoing, the establishment of a range of sold products by selecting from among product groups constituting completed products (manufactured products), such as two-wheeled and four-wheeled motor vehicles, those spare parts to be used in servicing.

As illustrated, the system comprises a client server system that is equipped with a drawing information server 10 as its server. The drawing information server 10 is connected to drawing information terminals 12, 14. The drawing information server 10 is also connected online through a drawing information terminal 16 to a part management information server 20. The part management information server 20 is further connected online to a part management information terminal 22 located in a procure/supply department and to a part management information terminal 24 or the like at the order department of each destination.

The drawing information server 10 and part management information server 20 constituting server side equipment are relatively large mainframes, while the drawing information terminals 12, 14 and all other terminals on the client side are microcomputers of smaller capacity.

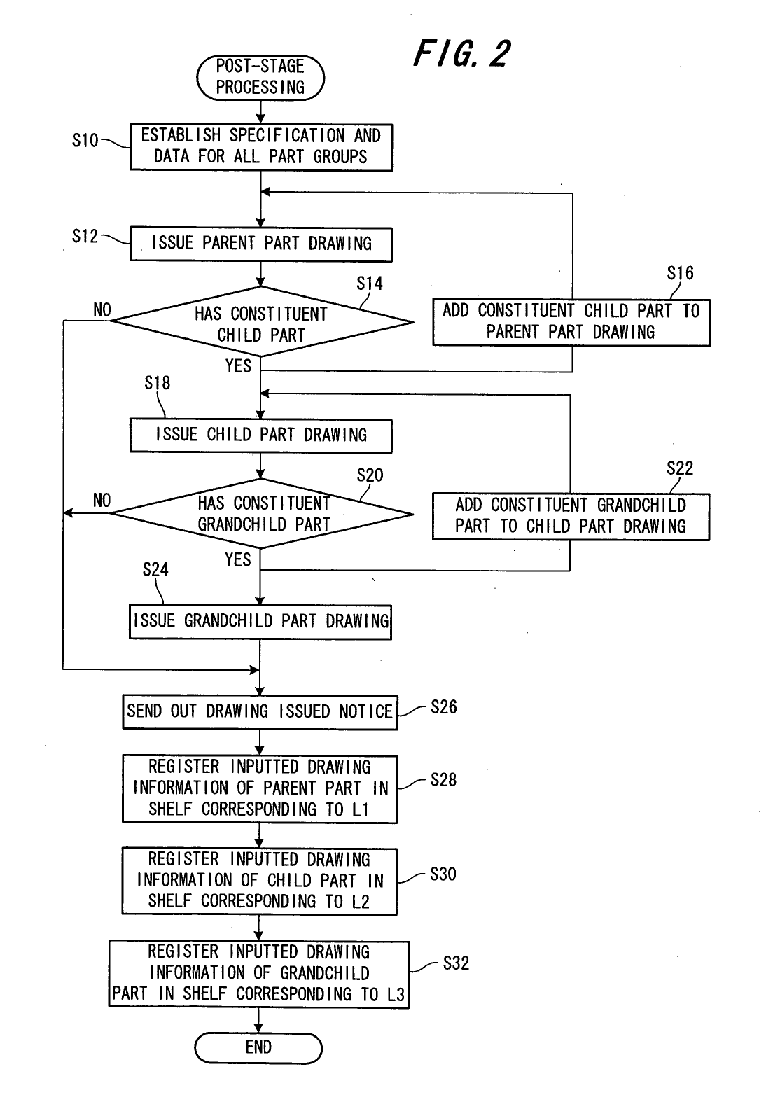

FIG. 2 is a flowchart showing the operation of the spare part lineup selection system according to this embodiment. Specifically, the flowchart of FIG. 2 shows the processing operations (first-stage processing) up to the point that drawing information is compiled into a database and registered in the drawing information server 10.

The first half of the illustrated program shows the actions of a human designer and the latter half shows the processing operations conducted by the drawing information terminal 12 of the system shown in FIG. 1 in response to inputs made by an operator (parts manager, for example) through a keyboard or the like of the drawing information terminals 12.

In S10, the designer establishes specifications and data for all part groups constituting newly marketed two-wheeled, four-wheeled and other completed motor vehicles.

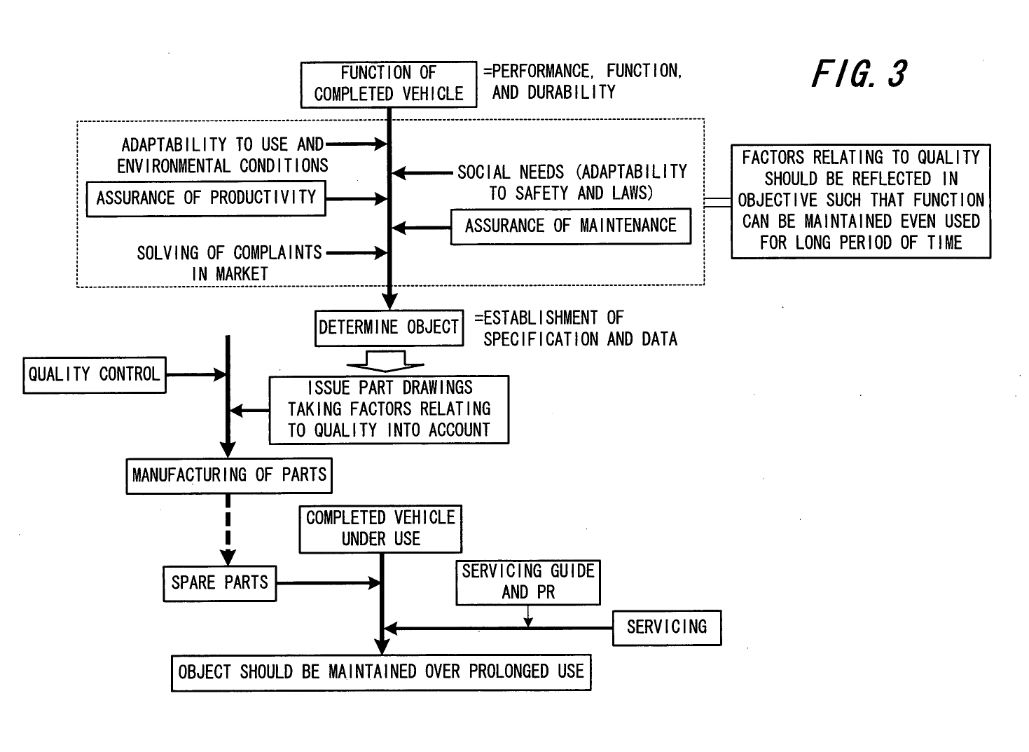

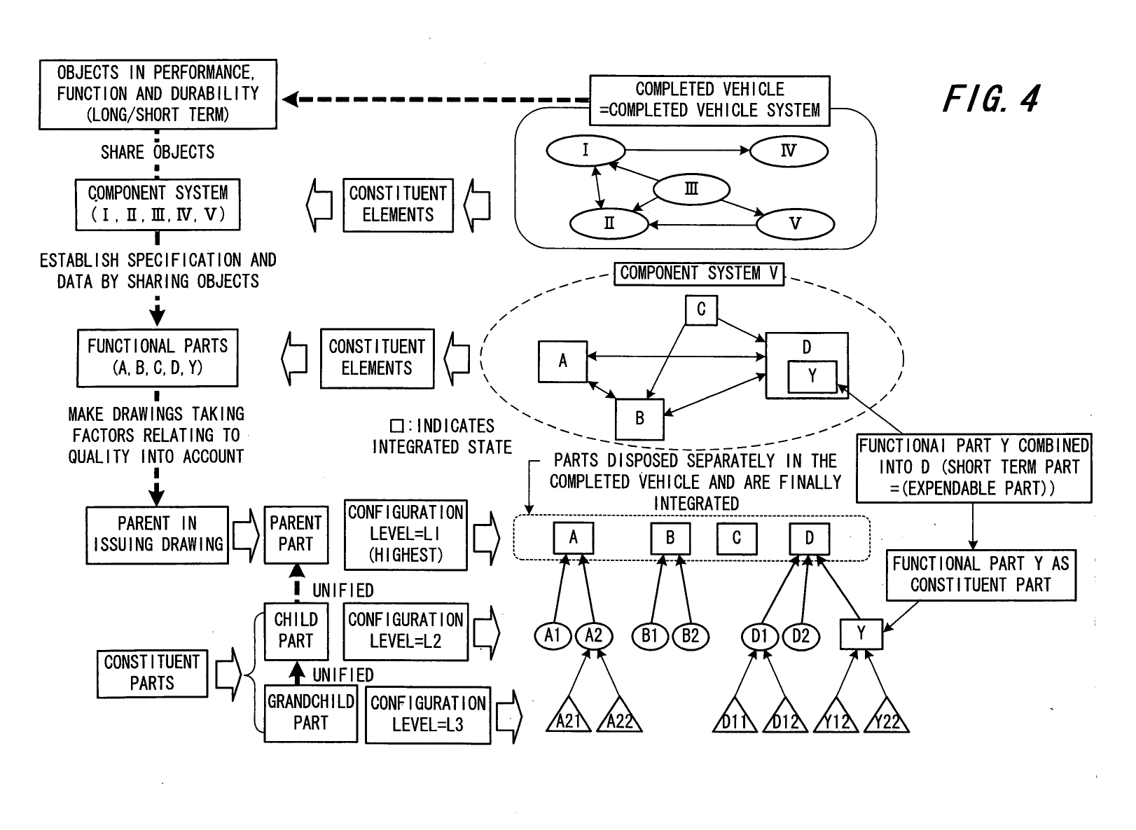

The explanation of FIG. 2 will be interrupted at this point to explain the “function assurance concept” on which the spare part lineup selection system of this embodiment is founded. The explanation will be made with reference to FIGS. 3 and 4.

FIG. 3 illustrates the function assurance concept that underlies the system according to this embodiment. It is a diagram for explaining the relationship between (a) the setting of desired functions to be performed by the completed vehicle and (b) the spare parts to be used in servicing.

The concept of function assurance underlies the system according to this embodiment. This will be explained with reference to FIG. 3. “Function assurance” is a warrantee-scheme concept underlying the development/design of the completed vehicle that is directed to achieving fundamental quality assurance. It is a concept of designing parts by taking into account ease of maintenance and quality assurance in servicing involving part replacement so as to realize the functions of the component systems (internal combustion engine etc.) that are the constituent elements of the completed vehicle and further to implement the specifications/data of the functional parts that are the constituent elements of the component systems.

In order to maintain the functions desired to be performed by the completed vehicle over prolonged use by the customer, it is necessary first to offer parts of assured quality for servicing that is manually carried out in a different manner from at the production plant and then to ensure high quality in the servicing work.

This function assurance concept, being the basic premise, is characterized by the thinking that if, for the purpose of reflecting factors that affect quality in the parts beforehand, parts of assured quality manufactured under quality control at the plant and the part drawings are supplied for use in servicing and a servicing guide setting out work procedures and methods is prepared in advance, it follows that the quality of the manual work involved in servicing will be ensured by the facilities, equipment and skills based on the servicing guide, so that it should be possible to achieve the objective of maintaining the functions of the completed vehicle in the course of use. The spare part lineup selection system according to this embodiment rests on this thinking.

The quality of the parts manufactured under quality control at the plant and the drawings for the parts is ensured at the time of manufacture, while ease of maintenance during servicing is ensured by the part drawings. Therefore, the desired servicing quality to be realized can be achieved using the parts and the separately prepared completed vehicle servicing guide.

FIG. 4 also illustrates the function assurance concept. It is a diagram for explaining concrete part design for achieving the desired completed vehicle functions. First, a completed vehicle such as a four-wheeled car is viewed as a system, then the component systems, such as the engine system, brake system, passenger compartment air condition system and the like (I, II, III, IV, V . . . ) are defined as the constituent elements, the functions of the completed vehicle system are allotted to these, and the component system specifications/data matched to the completed vehicle system are established in the light of various past experiences.

The constituent elements of the component systems are defined as functional parts (A, B, C, . . . ) and the individual functional parts are matched to the component systems and matched to the completed vehicle system in terms of the function they are to perform. By “matched” here is meant that in the replacement of a part with another part of the same type, the parts can always be installed in the completed vehicle with interchangeability. In other words, taking the component system V as an example, if the functional part B, which is one of the constituent elements, should fail, the component system V will recover its original function and the completed vehicle will perform the desired functions insofar as the replacement part is a functional part B.

A “functional part” means a constituent element of a component system which is a minimum unit part that performs a function matched to the purpose of the completed vehicle in its integrated state. “Integrated state” as termed here means the state of an assembly formed by physically connecting individual parts or groups of parts. At the same time, the functional parts are designed to ensure quality as replacement units.

A “parent part” is a part which is the parent of a drawing prepared taking into account factors related to the quality required as a precondition for maintaining the functions of the completed vehicle in the aforesaid course of use and which is independently installed integrally within the space of the completed vehicle. For example, the functional parts A, B, C, with consideration being given to factors related to their quality, directly form the parent parts A, B, C. The functional parts D, Y are, with consideration being given to factors related to quality, unified to form the parent part D, which is installed in the completed vehicle space. Further, it is a precondition of a parent part that it will be manufactured under the quality control of the production plant.

The term “constituent parts” means the group of parts forming an assembly of parts, i.e., the group parts forming a composite part. For example, in the case of the parent part A in FIG. 4, which is obtained by combining child parts A1, A2, the child parts A1, A2 are the constituent parts of the parent part A. In the case of the child part A2, which is obtained by combining the grandchild parts A21, A22, the grandchild parts are the constituent parts of the child part A2. On the other hand, the child part A1 is not a composite part and therefore no constituent parts are present.

Viewing the relationship between such a composite part and the constituent parts used therein from the functional aspect, the functions possessed by the individual constituent parts are functions performed to contribute to the composite part and the composite part performs a greater function than the constituent parts. In other words, a ranking exists among the functions to be performed (i.e., a ranking in the physical function). For example, where the function of the parent part is defined as a higher level function, the functions possessed by the child parts A1, A2 are lower level functions.

The term “configuration level” appearing in FIG. 4 is a unit for ranking functions where a composite part is defined as performing a higher level function and the constituent parts used therein are defined as being of lower level and also indicates the order of integration in part manufacture. Defining configuration level Ln as the unit, the parent part is positioned at the highest level, the child part at one level lower than the parent part, and the grandchild part at one level lower than the child part. The configuration level symbols obtained by encoding these configuration levels as Ln (n: 1, 2, 3, . . . ) form a symbol group indicating rank in the physical function.

Depending on the constituent part, the mode of integration, i.e., the mode of physical integration, can be fastening or joining. The former includes assembly and fastening and the later includes pressure-fitting, bonding, welding, casting and crimping.

Term “expendable part” appearing in FIG. 4, which is used in the context of functional parts being classified in terms of the durability function of the completed vehicle to reflect whether they are intended to be permanent, long-term or short-term, is defined to mean a functional part that is replaced at short intervals either because it deteriorates relatively quickly in the course of use or because replacement is required by law. For example, the parent part D is constituted of the child parts D1, D2, Y, among which the child part Y is an expendable part. Here, therefore, the term “expendable part” refers to the functional part Y.

The term “spare part” means a replacement part required in servicing for the purpose of maintaining the functions of the completed vehicle in the course of use. “Spare part lineup selection,” to define it once again, is a term used in the context of enabling servicing of completed vehicles in the future and/or of reflecting actual servicing conditions, to mean establishment of a spare part lineup by selecting from the group of parts constituting the completed vehicle that are to be used in servicing.

The spare part lineup selection system according to this embodiment is characterized in that it establishes a spare part line up by selecting the aforesaid functional parts, more specifically in that it determines as spare parts those which are expendable parts of the parent parts at the highest configuration level and of constituent parts at lower levels than the parent parts, thereby enabling parts and assemblies of parts of assured quality to be provided for use in maintenance.

The explanation of the flowchart of FIG. 2 will now be continued against the backdrop of the foregoing explanation. After the specifications and data of all parts groups constituting newly marketed two-wheeled, four-wheeled and other completed motor vehicles have been established in S10, the designer issues or prepares a parent part drawing for the respective parts in S12.

Next, in S14, a check is made as to whether the parent part has a constituent child part(s). When the result is YES, the constituent child part(s) is added to the parent part drawing in S16. Specifically, the part number and name of constituent child part and the way it is incorporated are added to the drawing. Next, in S18, the designer issues or prepares a child part drawing separate from the parent part drawing for the child part(s).

Then, in S20, a check is made as to whether the child part has a constituent grandchild part(s). When the result is YES, the constituent grandchild part(s) is added to the child part drawing in S22. Specifically, the part number and name of constituent grandchild part and the way it is incorporated are added to the drawing. Next, in S24, the designer issues or prepares a grandchild part drawing separate from the child part drawing for the grandchild part(s).

In this manner, the designer prepares part drawings for all constituent parts down to the unit part level beyond which the parent part cannot be further subdivided. This completes the preparation of the parent part drawing.

When the result in S14 or S20 is NO, the steps up to and including S24 are skipped.

Next, S26, the designer sends out or issues a “drawing issued notice” attached with the completed parent part and constituent part drawings in order to notify the department responsible for entering the part drawings in the database. The drawing issued notice is issued for supplying information on specifications and data and may be issued in two or more installments for the same part in the same model.

At the department responsible for entering the drawings in the database, the person in charge, upon receiving the drawing issued notice, uses the keyboard or other input device of the drawing information terminal 12 shown in FIG. 1 to input into a drawing issued notice provided in the drawing information server 10 for each issue NO, specifically into the register field of the drawing issued notice, the issue NO (and other information related to the drawing issued notice) and the drawing information entered in the part field of the part drawing attached with respect to the individual parent parts and constituent parts for which drawing issuance or preparation has been completed, specifically information such as the part numbers, part names, materials, and warnings (regarding fabrication and the like).

Each parent part and constituent part is identified by the issue NO of the drawing issued notice and the information entered in the part field of the attached part drawing, particularly by the issue NO and part number. The issue NO of the drawing issued notices (and the indications in the processing-use field and sell/no-sell field) and the information entered in the part fields of the attached part drawing therefore correspond to the aforesaid drawing information.

In addition, at the register field of each drawing issued notice of the drawing information server 10 is provided a storage field for one of the configuration level symbols Ln created by encoding the configuration levels (symbol group indicating rank in the physical function). As will be explained below with respect to the steps from S28 onward, the person in charge selects from among the configuration level symbols Ln the configuration level symbol (symbol) associated with each of the parts and/or part assemblies identified or specified by the drawing information and uses the keyboard or other input device of the drawing information terminal 12 to input the selected configuration level symbols.

A CPU of the drawing information terminal 12 that operates in accordance with commands stored in a ROM responds to input of the drawing information and selected configuration level symbols inputted by the person in charge (operator) by registering (storing) the inputted drawing information in the shelf corresponding to the selected symbol among the shelves provided for the respective configuration level symbol groups of the register field of the drawing issued notice in the drawing information server 10.

Specifically, in S28 the operator selects the configuration level symbol L1 for the parent part corresponding to the highest configuration level among the part groups entered in the part field of the part drawing and inputs it together with the part number and other drawing information. As a result, the CPU of the drawing information terminal 12 registers (stores) the inputted drawing information in the shelf corresponding to the configuration level symbol L1 among the shelves provided for the respective configuration level symbols in the register field of the drawing issued notice of the drawing information server 10.

In S30, the operator selects the configuration level symbol L2 for the child part corresponding to one configuration level lower than the parent part among the part groups entered in the part field of the part drawing and inputs it together with the part number and other drawing information. As a result, the CPU of the drawing information terminal 12 registers (stores) the inputted drawing information in the shelf corresponding to the configuration level symbol L2 among the shelves provided for the respective configuration level symbols in the register field of the drawing issued notice of the drawing information server 10.

In S32, the operator selects the configuration level symbol L3 for the grandchild part corresponding to one configuration level lower than the child part among the part groups entered in the part field of the part drawing and inputs it together with the part number and other drawing information. As a result, the CPU of the drawing information terminal 12 registers (stores) the inputted drawing information in the shelf corresponding to the configuration level symbol L3 among the shelves provided for the respective configuration level symbol groups in the register field of the drawing issued notice of the drawing information server 10.

If there is a constituent part falling at a still lower configuration level, the operator similarly selects the symbol corresponding to that lower level from among the configuration level symbols Ln, so that the inputted drawing information is registered (stored) in the shelf corresponding to that symbol among the shelves provided for the respective configuration level symbols in the register field of the drawing issued notice of the drawing information server 10.

In the register field of the drawing issued notice of the drawing information server 10, there is made ready a processing-use field into which a discrimination as to whether or not the spare part lineup selection has been completed (and the date) is automatically recorded. Specifically, a sell/no-sell field (explained later) is provided in addition to the processing-use field. When neither a sell symbol nor a no-sell symbol has been assigned to the sell/no-sell field, i.e., when the spare part lineup selection has not been made, the processing-use field is left blank, and when it has been made, the date the selection was completed is entered.

Thus the spare part lineup selection system according to this embodiment is characterized in that, assuming the forgoing spare part lineup selection that enables retrieval of all child parts and grandchild parts constituting parent parts, the processing system set out below is configured by replacing the logic of selecting expendable parts from among the parent parts at the highest configuration level and constituent parts at lower levels than the parent parts with the logic of selecting parts that are expendable parts from among parent parts specified by the drawing information registered in the shelves corresponding the configuration level symbol L1 and the parts specified by the drawing information registered in the shelves corresponding to the configuration level symbol L2, where the configuration level symbols are ones obtained by encoding the configuration levels in the drawing information server 10.

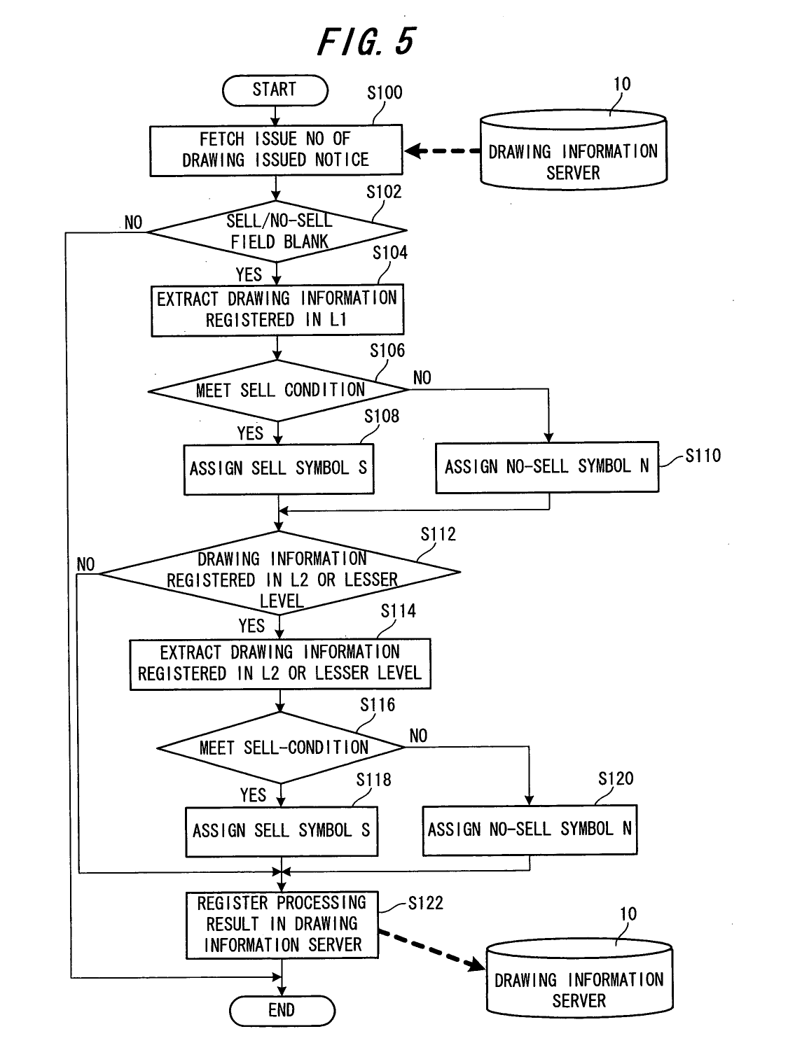

FIG. 5 is a flowchart showing operations of the spare part lineup selection system according to this embodiment that are executed following those of FIG. 2. The illustrated routine is executed by a CPU of the drawing information terminal 14 connected to the drawing information server 10 in accordance with commands stored in a ROM.

First, in S100, the drawing information server 10 is accessed to fetch (read) the issue NO of the drawing issued notice whose processing-use field is blank, i.e., for which the spare part lineup selection has not been completed. This is for reducing the processing load on the system by preventing redundant extraction of issue NO for which the spare part lineup selection has already been completed.

Next, in S102, it is checked whether the sell/no-sell field is blank. When the result is NO, the remaining processing steps are skipped because processing for spare part lineup selection is also unnecessary when the result is NO. When the result is YES, S104 is executed.

In S104, the drawing information registered in the shelf corresponding to the configuration level symbol L1 (the aforesaid prescribed first symbol) is extracted, whereafter, in S106, it is checked whether the part or part assembly identified or specified by the extracted drawing information (specifically, the part number therein) meets or comes under the sell condition.

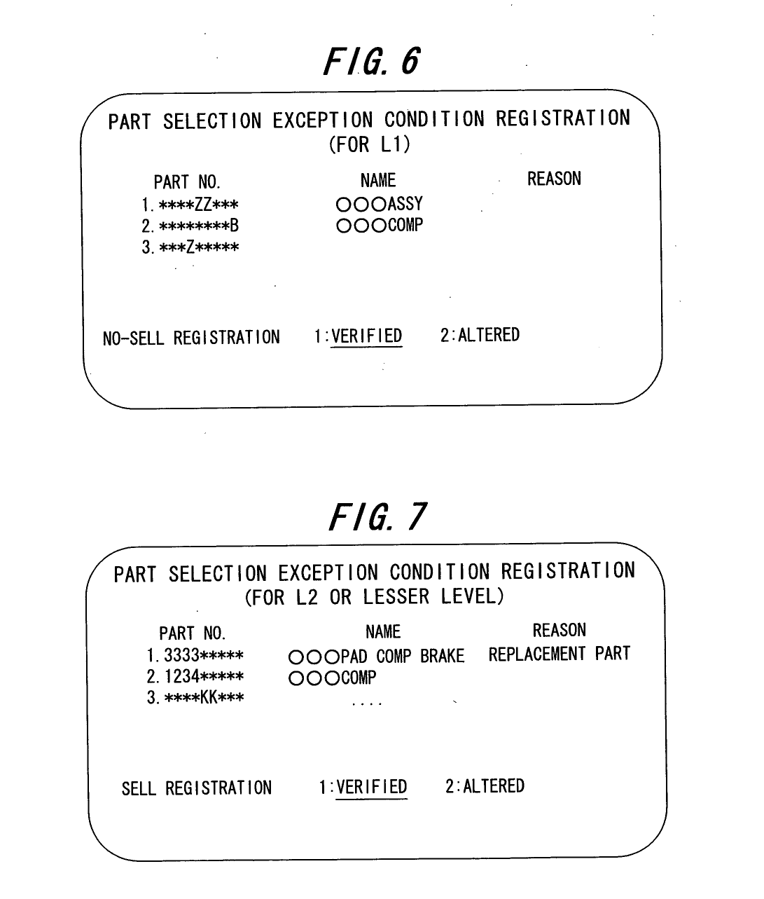

This check is conducted by using the extracted drawing information (specifically, the part number (NO) therein) to refer to (search) or check against parts or part assemblies that have been registered beforehand as being subject to part selection exception condition registration as shown in FIG. 6. The reason for this is that part numbers are usually composed of many digits, differ depending on the model of the completed vehicle, the aforesaid component system and/or the parent part type, and are redundant and complicated because they are structured to enable discrimination of the correlation between parent parts and their constituent parts. Therefore, as illustrated in FIG. 6, in exception condition registration, identification numbers are registered at some digits of the part number and these are referred to in S106.

Since the registrations shown in FIG. 6 are exception condition registrations to indicate no-sell, the result in S106 is YES when the reference (check or retrieval) does not find the part NO concerned. In such case, it is decided in S108 that the part or assembly of parts identified or specified by the extracted drawing information is a spare part that should be sold and a sell symbol S is assigned or entered in the sell/no-sell field in the register field of the drawing issued notice. On the other hand, when the result in S106 is NO, i.e., when the part number NO concerned is found among the part selection exception condition registrations shown in FIG. 6, it is decided that the part or assembly of parts identified or specified by the extracted drawing information is not a spare part to be sold. Then, in S110, a no-sell symbol N is assigned or entered in the sell/no-sell field in the register field.

Next, in S112, it is checked whether drawing information is registered in each of the shelves corresponding to the configuration level symbol L2 and lower level symbols (the aforesaid prescribed second symbol; specifically, L2, L3, L4, . . . ). When the result is YES, the drawing information is extracted in S114, whereafter it is checked in S116 whether the part or part assembly identified or specified by the extracted drawing information (specifically, the part number therein) meets or comes under the sell conditions.

This check is conducted by using the extracted drawing information (specifically, the part number (NO) therein), more exactly the identification number contained therein, to refer to (make a search of) the parts or part assemblies registered beforehand as being subject to part selection exception condition registration as shown in FIG. 7. Since the registrations shown in FIG. 7 are exception condition registrations to indicate sell, the result in S116 is YES when the reference (check or retrieval) finds the part NO concerned. Then, in S118, it is decided that the part or assembly of parts identified or specified by the extracted drawing information is a spare part that should be sold and a sell symbol S is assigned or entered in the sell/no-sell field in the register field.

On the other hand, when the result in S116 is NO, i.e., when the part number NO concerned is not found among the part selection exception condition registrations shown in FIG. 7, it is decided that the part or assembly of parts identified or specified by the extracted drawing information is not a spare part to be sold. Then, in S120, a no-sell symbol N is assigned or entered in the sell/no-sell field in the register field.

Next, in S122, the processing result is registered in the processing-use field of the drawing issued notice of the drawing information server 10, i.e., the time and date when the sell symbol or no-sell symbol was assigned or entered is recorded. This completes the registration of the parts and part assemblies as spare parts. When the result in S112 is NO, the routine jumps to S122.

Next, the issue NO of new unprocessed drawing issued notice is read and similar processing is repeated.

The foregoing is characterized in one aspect in that parts and part assemblies identified or specified by drawing information registered in the shelves corresponding to the configuration level symbol L1 of the drawing information server 10 are preset as “sell” and parts and part assemblies identified or specified by drawing information registered in the shelf corresponding to configuration level symbol L2 and lower level symbols are preset as “no-sell.”

This will be explained. The parts and part assemblies identified or specified by the drawing information registered in the shelves corresponding to the configuration level symbol L1 are the aforesaid parent parts and, as such, are functional parts.

A parent part is a part that is matched to the desired function of the completed vehicle in its integrated state and that performs a function at the highest configuration level. In other words, it is a replacement unit part of assured quality that does not require any additional work of replacement part disassembly and reassembly.

The converse of this is the reason why the parts and part assemblies identified or specified by the drawing information registered in the shelves corresponding to the configuration level symbol L2 and lower level symbols are preset as “no-sell.” In other words, these parts and part assemblies, with the exception of the expendable parts among them, do not fall within the definition of functional parts and can only perform a function when incorporated into a part or part group specified by drawing information registered in a shelf corresponding to a configuration level symbol L1.

Assume, for example, that the parent part A shown in FIG. 4 to be registered at the (shelf corresponding to) configuration level symbol L1 has the child part A1 registered at the (shelf corresponding to) the configuration level L2 incorporated therein by pressure-fitting. In such a case, if the child part A1 should be sold for use in servicing in its state before pressure-fitting, the servicing would have to be conducted by removing the parent part A from the completed vehicle, disassembling it and then pressure fitting the child part A1 during reassembly. Because of the different manual work involved, this would make it difficult to ensure the same quality of the reassembled parent part A as that of the original parent part A of assured quality manufactured under quality control at the plant.

Moreover, the notion of designing a spare part taking into account factors that affect the required quality does not extend to giving consideration to the work of disassembling the parent part A and reassembling by pressure-fitting. Therefore, if such reassembly work should be included in servicing, measures would have to be implemented to ensure that quality is maintained by avoiding mistakes in the manual work and unexpected circumstances that might arise owing to such mistakes. For this, special servicing guides setting out work procedures and methods, special equipment and special skills would have to be made available with respect to all part types in a large number of categories. This would not be practical.

Another distinctive feature here is that the parts and part assemblies identified or specified by the drawing information registered in the shelves corresponding to the configuration level symbols L1, L2 and lower level symbols are, at the time of making the decisions in S106 and S116, checked against the parts and assemblies registered as falling under the exception conditions of FIGS. 6 and 7 to determine whether they meet the “sell” conditions, i.e., whether they meet the conditions for inclusion in lineup of spare parts to be sold. They are determined to be spare parts when the result of the check is affirmative.

The parts and part assemblies registered beforehand as falling under the exception conditions shown with respect to the configuration level symbol L1 in FIG. 6 are ones that do not meet the definition of parent parts to be included in the spare part lineup in this spare part lineup selection system. Namely, they are parts and assemblies for which no drawings setting out specifications and data particulars are available, parts and part assemblies existing only in drawings and not in actuality, and parts and part assemblies that actually exist but are restricted from inclusion in the spare part lineup by contracts, laws or regulations. Insofar as a part or part assembly does not fit any of these descriptions, it is decided for inclusion in the spare part lineup.

On the other hand, the parts and part assemblies registered beforehand as falling under the exception conditions shown with respect to the configuration level symbol L2 and lower level symbols in FIG. 7 are “functional parts” to be included in the spare part lineup in this spare part lineup selection system. Namely, they are expendable parts that are components of the parent parts. The reason for selling these functional part included among the constituent parts preset as “no-sell” is that it is rational to sell them and also because it makes it possible to respond well to the needs of the end user.

For example, in FIG. 4, the functional part Y that is a constituent part of the parent part D is an expendable part. Although selling only the parent part D for use in servicing makes it possible to simultaneously replace the expendable part Y because it is a component of the parent part D, the expendable part Y can, as pointed out earlier, be expected to require replacement in accordance with its degree of deterioration within a relatively short period. On the other hand, replacing the parent part D every time the expendable part requires replacement would result in discarding of the portion of the parent part D other than the expendable part Y, which has not yet deteriorated and is still usable. This would cause economic loss, be unreasonable, and run counter to the needs of the end user. Insofar as a part or part assembly fits this description, it is decided for inclusion in the spare part lineup.

The ensuing flow of operations with respect to the registered spare part lineup will now be explained with reference to FIG. 1. Among the parts registered in the drawing information server 10, only the parts and part assemblies assigned the sell symbol S are automatically fetched as spare parts via the part management department drawing information terminal 16 connected online to the drawing information server 10 and registered in the part management information server 20. The part management information server 20 is connected online to the part management information terminals 22, 24 installed at the procure/supply department and the order department of each domestic and overseas destination. The spare parts ordered in the domestic and overseas markets via the part management information terminals 22, 24 by the persons in charge at these departments are procured and supplied to the department that placed the order.

In order to provide required servicing for newly marketed completed vehicles as completed vehicles in the course of use, spare parts are supplied as spare parts selected for inclusion in the “sell” lineup in the foregoing manner.

Thus, the embodiment is configured to have a system for selecting a spare part lineup by determining which part or part assembly among a group of parts constituting a completed product is to be sold and having a drawing information server (10); characterized in that: a drawing information terminal (12, S10-S24) connected to the drawing information server (10) and, after a drawing has been issued for each part or part assembly of the group of parts constituting the completed product and a symbol (Ln) has been selected from among a group of symbols indicating rank in physical function and prepared to be assigned to the group of parts constituting the completed product, allows an operator to input information of the drawing that identifies the part or part assembly, together with the selected symbol; a drawing information register (drawing information terminal 12, S28-S32) that registers the inputted drawing information in a shelf corresponding to the selected symbol from among shelves provided in the drawing information server for the respective symbols; a drawing information extractor (drawing information terminal 14, S100-S104) that accesses the drawing information server and extracts the drawing information registered in one from among the shelves that correspond to a predetermine first symbol (L1); and a spare part line up register (S106-S122) that determines and registers in the drawing information server that the part or part assembly identified by the drawing information extracted from the shelf corresponding to the predetermined first symbol is a spare part to be sold.

Therefore, it is possible with respect to the group of parts constituting the completed product (manufactured product) to decide simply and quickly whether or not they are to be sold, thereby determining a spare part lineup, and also to avoid misjudgments and mistakes in deciding the lineup and to improve work efficiency. As a result, increase in inventory can be prevented even when an increase in the number of completed models causes an increase in the number of part groups.

In addition to the foregoing effects, it is also possible to achieve an improvement in the servicing quality. This is because the prepared part drawings reflect in advance productivity and ease of maintenance as factors that have an effect on maintaining quality during servicing, so that the part drawing and the products manufactured under quality control by the manufacturing department are assured of quality in manufacture and also assured of ease of maintenance. As a result, realization of quality in the maintenance work can be a precondition. If that is true, then the functions set out on the part drawings should be correctly read and the parts to which this precondition applies should be selected as spare parts.

By thus defining design and part drawing to be the source of quality, it becomes possible to provide spare part lineup selection processing that incorporates a common concept and can serve as a standard in analysis and judgment regarding achievement of quality in servicing and to ensure quality and realize improved work efficiency in servicing completed products, thereby making it possible to deal with the ongoing increase in number of models and to eliminate economic loss.

In the system, the drawing information extractor accesses the drawing information server and extracts the drawing information registered in one from among the shelves that correspond to a predetermined second symbol (L2, L3, . . . , S112-S114), and the spare part lineup register determines and registers in the drawing information server that the part or part assembly identified by the drawing information is not the spare part to be sold (S116-S122). Therefore, it is possible with respect to the group of parts constituting the completed product (manufactured product) to decide simply and quickly whether or not they are to be sold, thereby determining a spare part lineup, and also to avoid misjudgments and mistakes in deciding the lineup and to improve work efficiency. As a result, increase in inventory can be prevented even when an increase in the number of completed models causes an increase in the number of part groups.

In the system, the rank in the physical function is set at a highest level for the part or part assembly that perform a predefined function and is set at a lower level for part or part assembly that does not perform the predefined function, and the prescribed first symbol (L1) is a symbol indicating the highest level, whereas the prescribed second symbol (L2, L3, . . . ) is a symbol indicating the lower level. Therefore, it is possible with respect to the group of parts constituting the completed product (manufactured product) to decide simply and quickly whether or not they are to be sold, thereby determining a spare part lineup. Moreover, the result is that the parts and part assemblies that themselves perform a predefined function are decided to be spare parts to be sold and the parts and part assemblies that do not themselves perform a predefined function are decided not to be spare parts to be sold. An improvement in servicing quality is therefore realized in addition to the foregoing effects.

In the system, the spare part lineup register includes: a discriminator (S106) that discriminates whether the part or part assembly identified by the drawing information extracted from the shelf corresponding to the predetermined first symbol meets sell condition; and determines and registers in the drawing information server that the part or part assembly identified by the drawing information extracted from the shelf corresponding to the predetermined first symbol is the spare part to be sold, when the part or part assembly is discriminated to meet the sell condition (S108, S122). Therefore, in addition to the foregoing effects, it becomes possible to achieve rational supply of spare parts and also to respond well to the needs of end users.

In the system, the spare part lineup register includes: a discriminator (S116) that discriminates whether the part or part assembly identified by the drawing information extracted from the shelf corresponding to the predetermined second symbol meets sell condition; and determines and registers in the drawing information server that the part or part assembly identified by the drawing information extracted from the shelf corresponding to the predetermined second symbol is the spare part lineup to be sold, when the part or part assembly is discriminated to meet the sell condition (S118-S122). Therefore, in addition to the foregoing effects, as in the fourth aspect, it becomes possible to supply spare parts flexibly and also to respond well to the needs of end users.

In the foregoing, the term “part or part assembly” is used in a sense including both the case where the completed part is constituted of a single member and the case where the completed part is constituted of a plurality of members.

Again explaining the advantages of the embodiment, this enables simple and appropriate decisions regarding whether or not specific ones of the parts constituting a completed vehicle such as an automobile should be sold and thus to determine the lineup of spare parts. It thus prevents the occurrence of misjudgments and mistakes in deciding the lineup and also improves work efficiency.

More specifically, a computerized processing system is provided that replaces the logic structure common to completed vehicle models of selecting functional parts from among product groups shown in part drawings with the logic of, in a database, selecting parts or part assemblies specified by drawing information extracted from shelves corresponding to symbols of the highest level among a symbol group indicating function rank, using sell conditions to judge them, and determining those for which the judgment is affirmative as spare parts. As a result, it becomes possible to eliminate fundamentally not only the misjudgments, mistakes in defining the lineup and processing oversights that arise when the selection of spare part is conducted manually as in the prior art but also the work time lost owing to the need to take new measures to deal with these problems. In addition, it becomes possible to process a large quantity of new parts in a relatively short time, so that the overall efficiency of the processing work is enhanced.

Therefore, an increase in the number of product groups owing to an increase the number of completed vehicle models does not produce an increase in inventories. Moreover servicing quality can be upgraded.

Further, the spare part lineup selection system according to this embodiment has the following ripple effect. At the time of the processing work for making “sell” and “no-sell” decisions and registering parts in the database, all tasks including analysis, determination, decision-making and processing can be automated using small-capacity personal computers (the drawing information terminals 12 and 14). As a result, other than for certain decision tasks, these tasks themselves become unnecessary, time lags with regard to the spare parts can be eliminated by networking the database, and the accuracy of the work can also be improved.

In addition, since function assurance rooted in the function and quality of parts set out in drawings is defined as the underlying concept and parts that are sold on an exception basis are defined as expendable parts and the like, it follows that the part types included in the lineup are limited to the minimum required, without including any other parts, and that a lineup adequate for servicing needs can be established. In other words, the fact that the functional effect based on the aforesaid function assurance concept and reinforced by the part drawings can be achieved together with quality, free of any conflict therebetween, precludes any need for including any other parts in the lineup.

Owing to the fact that the spare part lineup selection system according to this embodiment is adapted to select functional parts and include them in the lineup of “sell” products, it not only is capable of supplying replacement unit spare parts of assured quality but also has an effect of ensuring quality by eliminating the need to further disassemble and reassemble spare parts supplied for use in servicing.

Although a two-wheeled or four-wheeled vehicle was taken as an example of the product in the foregoing, the invention is not limited to application to a two-wheeled or four-wheeled vehicle but is appropriate for application to any completed product whose function is maintained in the course of use by servicing using supplied spare parts.

Japanese Patent Application No. 2003-314115 filed on Sep. 5, 2003, is incorporated herein in its entirety.

While the invention has thus been shown and described with reference to specific embodiments, it should be noted that the invention is in no way limited to the details of the described arrangements changes and modifications may be made without departing from the scope of the appended claims.

1. A system for selecting a spare part lineup by determining which part or part assembly among a group of parts constituting a completed product is to be sold and having a drawing information server; comprising:
a drawing information terminal connected to the drawing information server and, after a drawing has been issued for each part or part assembly of the group of parts constituting the completed product and a symbol has been selected from among a group of symbols indicating rank in physical function and prepared to be assigned to the group of parts constituting the completed product, allows an operator to input information of the drawing that identifies the part or part assembly, together with the selected symbol;
a drawing information register that registers the inputted drawing information in a shelf corresponding to the selected symbol from among shelves provided in the drawing information server for the respective symbols;
a drawing information extractor that accesses the drawing information server and extracts the drawing information registered in one from among the shelves that correspond to a predetermine first symbol; and
a spare part line up register that determines and registers in the drawing information server that the part or part assembly identified by the drawing information extracted from the shelf corresponding to the predetermined first symbol is a spare part to be sold.

2. The system according to claim 1, wherein the drawing information extractor accesses the drawing information server and extracts the drawing information registered in one from among the shelves that correspond to a predetermined second symbol, and the spare part line up register determines and register in the drawing information server that the part or part assembly identified by the drawing information is not the spare part to be sold.

3. The system according to claim 1, wherein the rank in the physical function is set at a highest level for the part or part assembly that perform a predefined function and is set at a lower level for the part or part assembly that does not perform the predefined function, and the prescribed first symbol is a symbol indicating the highest level, whereas the prescribed second symbol is a symbol indicating the lower level.

4. The system according to claim 1, wherein the spare part line up register includes:
a discriminator that discriminates whether the part or part assembly identified by the drawing information extracted from the shelf corresponding to the predetermined first symbol meets sell condition;
and determines and registers in the drawing information server that the part or part assembly identified by the drawing information extracted from the shelf corresponding to the predetermined first symbol is the spare part to be sold, when the part or part assembly is discriminated to meet the sell condition.

5. The system according to claim 2, wherein the spare part line up register includes:
a discriminator that discriminates whether the part or part assembly identified by the drawing information extracted from the shelf corresponding to the predetermined second symbol meets sell condition;
and determines and registers in the drawing information server that the part or part assembly identified by the drawing information extracted from the shelf corresponding to the predetermined second symbol is the spare part lineup to be sold, when the part or part assembly is discriminated to meet the sell condition.
